(19) United States
(12) Patent Application Publication
(10) Pub. No.: US 2019/0242356 A1
(43) Pub. Date: Aug. 8, 2019

(54) Mass Activated Generator

(71) Applicant: Ezatola Ebrahimi, Dallas, TX (US)

(72) Inventor: Ezatola Ebrahimi, Dallas, TX (US)

(21) Appl. No.: 15/888,470

(22) Filed: Feb. 5, 2018

(51) Int. Cl. F03B 7/00; F03B 15/00

(52) U.S. Cl. CPC F03B 7/006; F03B 15/005

(57) ABSTRACT

A mass activated generator to generate torque, including a power drop device to receive liquid to drive a continuous loop device to generate the torque; a mass activated pump to receive the liquid from the continuous loop device and to pump the liquid to the continuous loop device. The continuous loop device includes a pair of torque shafts to drive an electric generator and a plurality of power drop containers connected to the torque shafts to receive the liquid and to transfer the liquid to the mass activated pump.

### FIELD OF THE INVENTION

The present invention relates to energy generation and more particularly to a Mass Activated Generator.

### BACKGROUND

In the past, various sources of power generation have been employed including wind, solar and fossil fuel generating plants.

### SUMMARY

The Mass Activated Generator 100 (MAG) is a system designed to produce energy including electricity, among other functions. Much like other systems that produce Wind and Solar Energy, the Mass Activated Generator employs proven scientific techniques and formulas in order to take advantage of the available natural forces for producing electricity, or to perform boundless other functions, at almost no operational cost.

Also, the functionality of this mass activated generator system 100 is far more versatile than both Wind and Solar Energy production methods employed today. The MAG 100 is versatile enough to aid NASA in any future trip to Mars, or any other planet that might have a limited amount of water (or other incompressible liquids), that they can used to generate electricity. Throughout, the present invention refers to water as the liquid used to produce torque. However, the MAG 100 works equally well with other liquids, as long as the liquid to be used is incompressible. This requirement is imposed by the Pascal's Laws.

Major Components:

The MAG 100 may include three main components, two of which are designed for the present invention. The third major component may be some form of large liquid containers, or tanks. The MAG 100 also employs several other components, such as Gears, Shafts, Clapper Valves, shut-off valves, etc.

The major components may include:
1. The Mass Activated Pump (MAP), is a major component of the present invention designed for MAG 100.
2. The Power Drop (PD), is the second component of the present invention for MAG 100.
3. The other components are two of the many forms of liquid containers such as the first container 106 and the second container 108, for example tanks. In most implementations MAG employs only two of these containers.
Since the MAG 100 can be implemented in many different cascading forms, the above numbers of components can change for each implementation of the present invention, depending on the particular cascading form and the expected capacity.

The MAG 100 takes advantage of two well-known scientific laws in order to perform its functions. The use of these laws makes it possible to use the weight of the liquid as the input force to the MAG 100. Scientific Laws employed:
1. Stevin's Law of “Communicating Vessels”. This law is also sometimes simply called the “Law of Communicating Vessels”.
2 Pascal's Law of Transmission of Fluid-pressure within confined incompressible liquid.

### BRIEF DESCRIPTION OF THE DRAWINGS

FIG. 1 illustrates a flow diagram of the mass activated generator of the present invention;

FIG. 2 illustrates a perspective diagram of the power drop of the mass activated generator of the present invention;

FIG. 3 illustrates a cross-section of the mass activated pump of the present invention;

FIG. 4 illustrates a perspective view of the power drop of the mass activated generator of the present invention;

FIG. 5 illustrates a cross-sectional view of the mass activated pump and PD 11 are herein, of the mass activated generator of the present invention;

FIG. 6 illustrates a more detailed cross-sectional view of the mass activated pump of the mass activated generator of the present invention;

### OVERALL FUNCTION

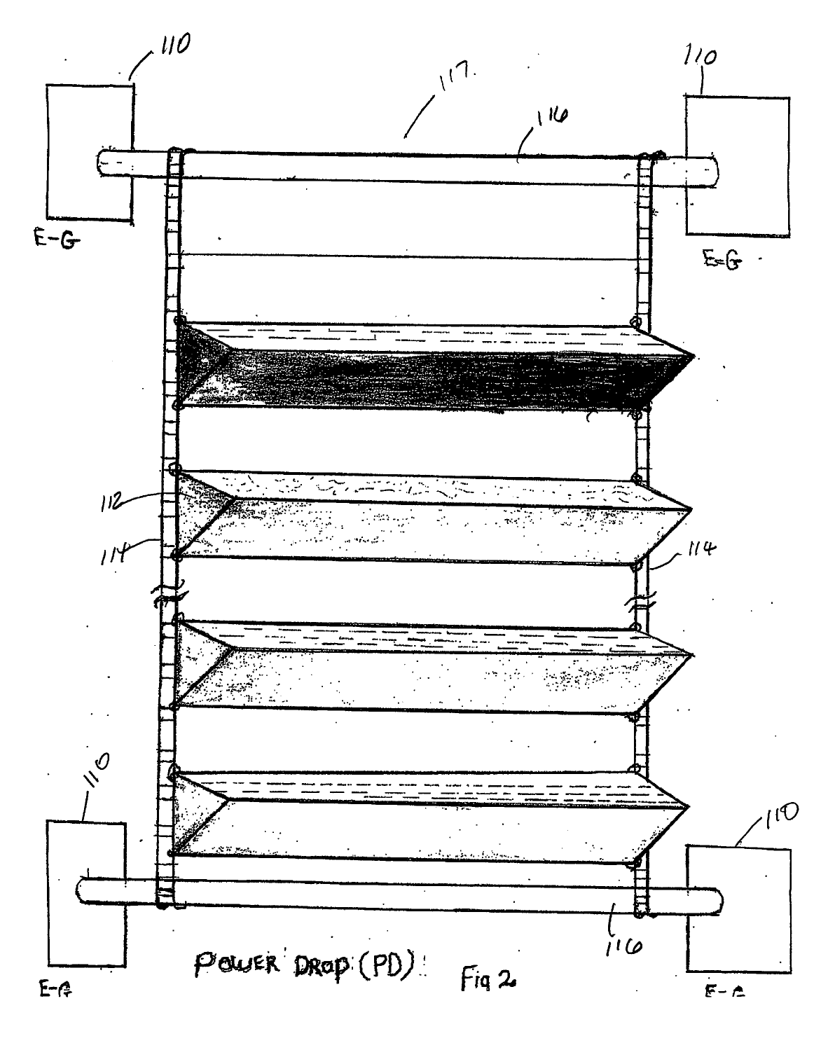

FIG.-1 illustrates the overall structure and function of the mass activated generator system 100 and the inner relationship of its components in a block diagram form. FIG. 2 illustrates a portion of the mass activated generator system including the power drop device 104 and generators 110. FIG. 4 illustrates additional structure of the power drop component 104 to make it easier to understand the overall function of the whole system, as well as depiction of how each device relates to other devices of the mass activated generator 100. FIGS. 2-6 illustrate details of mass activated generator 100.

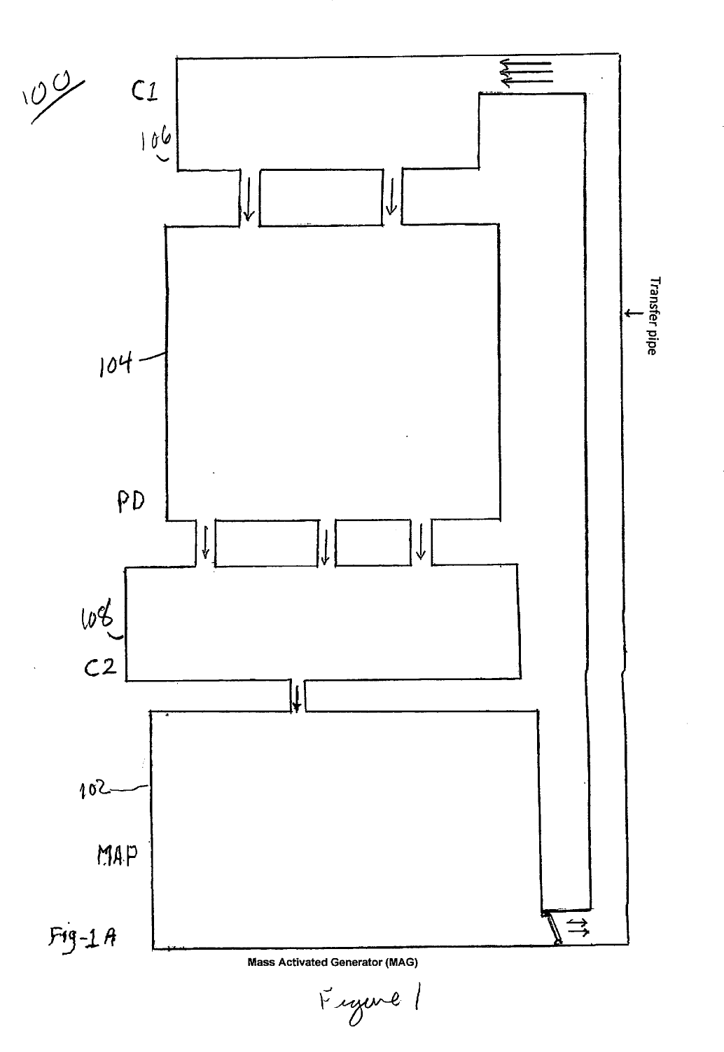

The process and apparatus of the present invention may be described and can be visualized by following the interconnections and the flow directions in FIGS. 1-6. It is also important to bear in mind that the details of the functions of each component will be provided in the appropriate section. The present section presents an overall description of the system function, as well as the relationship between the components.

In order to generate torque to generate electricity from the power generators 110, the MAG 100 employs a device called Power Drop device 104 (PD). In fact, the functioning of the whole mass activated generator system 100 begins when water from the first liquid container 106, begins to fill the containers 112 of the PD 104. The power drop 104 may include a multitude of power drop containers 112 which may be substantially V-shaped and may be connected by a shaft (not shown) at opposing ends of the power drop containers 112 to a pair of belts/chains 114. The belts/chains 114 may be mounted ono a pair of torque shafts 116 and may be positioned vertically. The weight of the water contained in these power drop containers 112 will force a downward movement of the power drop containers 112, and the belt/chain 114 will carry the pivoting containers 112 downwards, forcing the torque shaft 116 to rotate, generating power from the power generators 110. Where torque shafts 116 are connected to one or more Electric Generators 110 depends on the size and the requirements of these generators 110. The liquid then is deposited from the power drop containers 112 into the second liquid container 108 when each power drop container 112 reaches the bottom of the power drop 104. This process continuously operates with the next power drop container 112, while each empty power drop container 112 (now empty) moves up the power drop 104, from behind the belts-chain 114, to the top of the power drop 104 to be refilled. It should be mentioned at this point that it is absolutely necessary for the liquid to be of the incompressible type. Otherwise, although the power drop PD 104 works with any type of liquid, the Mass Activate Pump 102, which uses Pascal's Laws for its functionality, does not function with compressible liquids. The power drop PD 104 transforms the potential energy of the water in the first liquid container 106 into torque, and subsequently into electricity.

The next step in the process is fulfilled by the designed device, the Mass Activated Pump (MAP) 102.

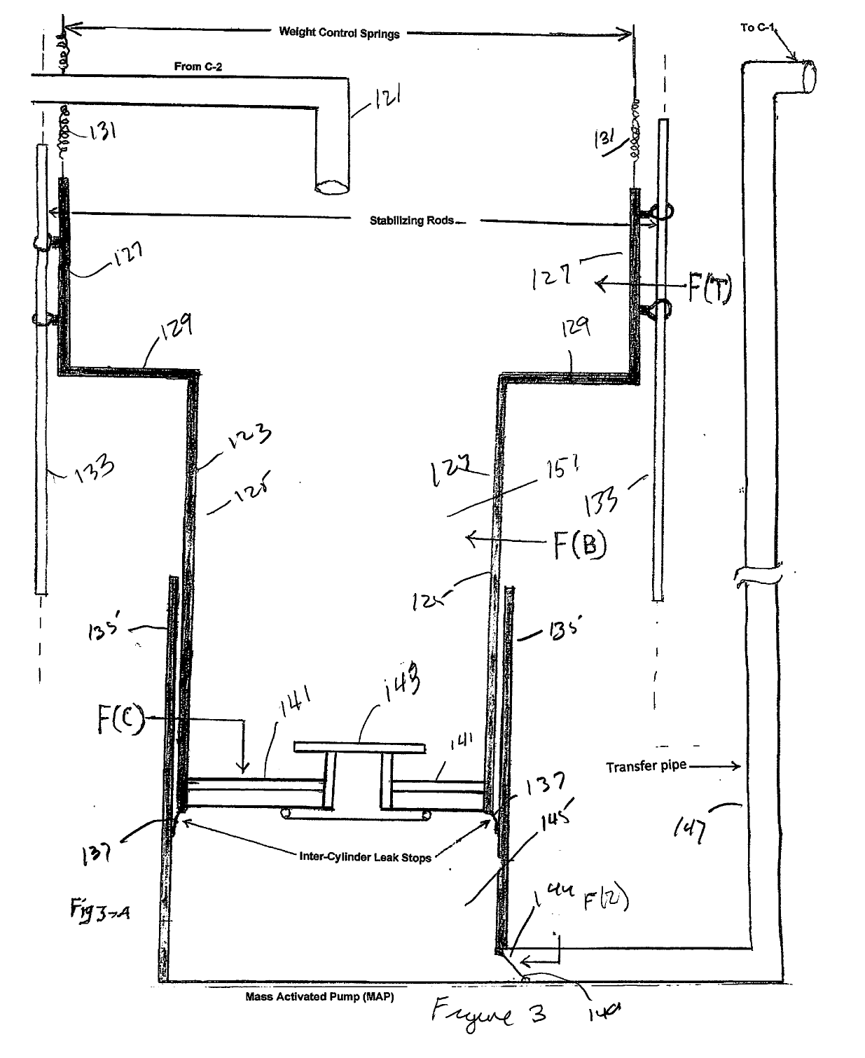

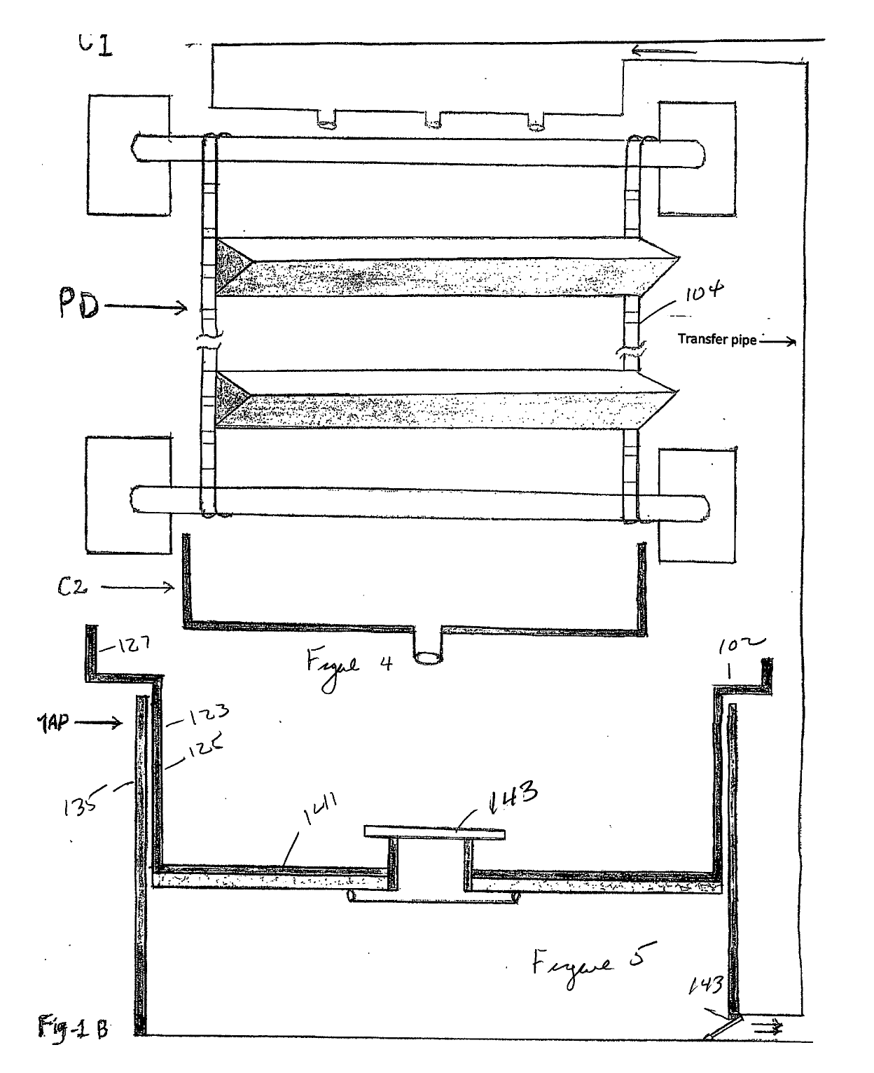

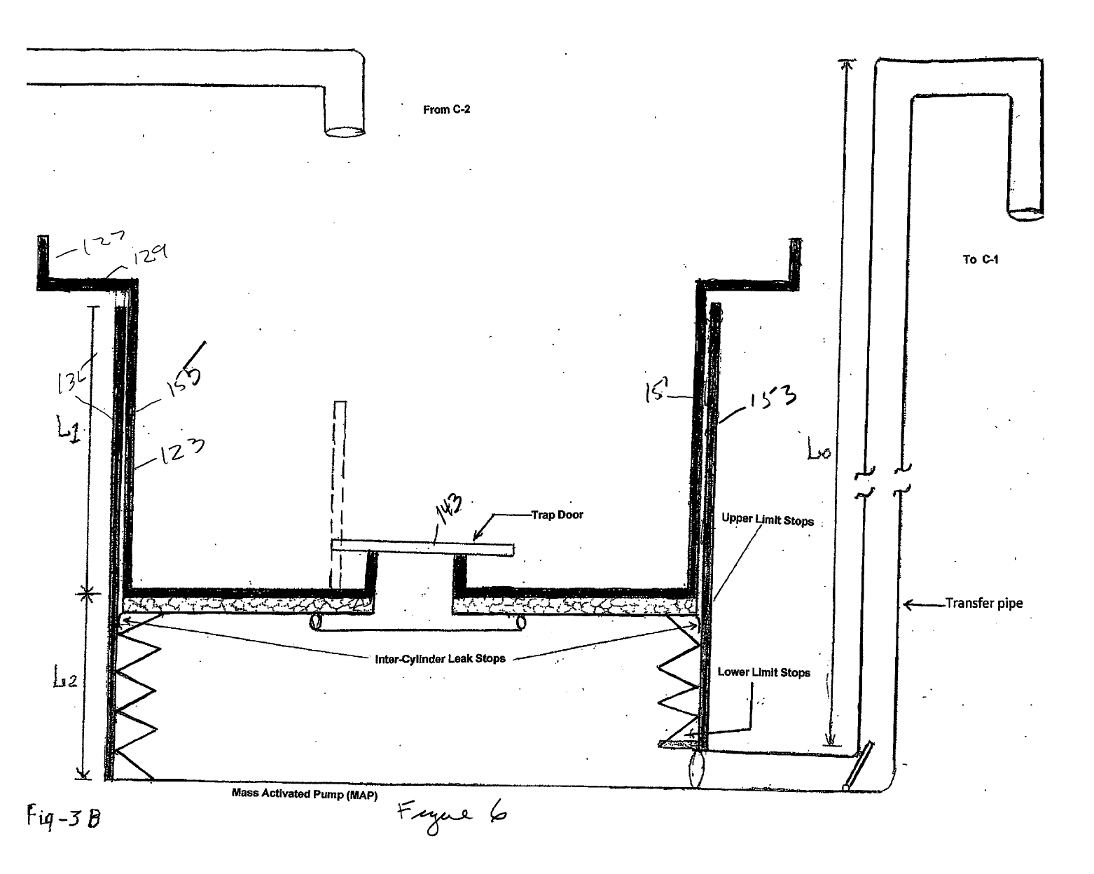

FIG. 3 illustrates the mass activated pump 102 which may include an input pipe 121 from the second liquid container 108 to deliver liquid to the mass activated pump 102 and which may include a mass power pump wall 123 which may include first vertical wall 125, a second vertical wall 127 and both of which may be connected to a horizontal wall 129. The second vertical wall 127 may be connected to a pair of opposing weight control springs 131 to move the mass power pump wall 123 up or down in accordance with the weight of the liquid from the input pipe 121. In addition, the second vertical wall 127 may be slide-ably connected to stabilizing rods 133 to stabilize the movement of the mass activated pump 102 and the first vertical wall 125 may cooperate with guide walls 135 to stabilize the movement of the mass activated pump 102. The first vertical wall 125 may include wall seals 137 to seal the liquid from the guide walls 135. At the end of the road vertical wall 125 may be connected to a bottom wall 141 which may include a bottom valve 143 which may be operated to drain the mass activated pump 102 into a bottom cavity 145 defined by the guide walls 135. The bottom cavity 145 may be in liquid communication with a transfer pipe 147 by virtue of a transfer valve 149 which controls the flow of liquid from the bottom cavity 145 to the transfer pipe 147. The upper cavity 151 may be defined by the bottom wall 141 and the mass power pump wall 123.

Once the liquid flows into the second liquid container 108 from the power drop PD 104 a valve opens and causes the liquid from the second liquid container 108 to flow into the cavity 151 of the Mass Activated Pump 102. Once a first predetermined amount of liquid has been deposited into the upper cavity 151 of the mass activated pump 102. The mass activated pump MAP 102 will begin its functioning. At this point, by manipulating Pascal's law, the mass activated pump MAP 102 delivers a second predetermined amount of liquid (not necessarily the same amount of liquid) into the first liquid container 106, which may be positioned at the highest elevation of the entire system 100.

To simply state it, while the power drop PD 104, used the potential energy of the water in the first container 106 to generate electricity by the power generators 110, the mass activated pump 102 restores the potential energy of the liquid by replacing the liquid removed from the first liquid container 106.

This illustrates at least one cycle of the system 100, and this process will continue from the first cycle. Depending on the implementation and capacity requirements by the user, these processes will not always function in the series form. There are implementations in which both mass activated pump 102 and the power drop 104 may operate simultaneously. In such formats, the mass activated pump 102 may operate as two or more mass activated pumps and the power drop 104 may operate as two or more power drops, each one operating independently of any of the other devices

This is of utmost importance to emphasis that Mass Activated Generator 100 obeys the first law of Thermodynamics, conservation of energy. The total input energy of this system does equal the total output energy, with the advantage being that the input is provided through scientifically employing the available natural forces of gravity.

Component Description:

Following sections will describe the functionality of each of the new components, as well as the relationship of that component to the rest of the system. The formulas as well as the related calculations to be performed are described in these sections. However, some of the calculations are implementation dependent and can only be performed once the torque requirements of the generators are determined.

Power Drop (PD):

The power drop PD 104 is the component within the mass activated generator MAG 100 that generates the torque necessary for generating electricity with the power generators 110. The descriptions in this section are depicted in FIG. 2.

The power drop PD 104 may include two shafts 116 being secured vertically into a frame 117, being spaced apart about ten vertical feet or other selected distance. At each end of each shaft 116 one gear (not shown) is fastened so that the gears on each shaft 116 is the approximately 6 horizontal feet apart. Also, these gears may be positioned in a way that the gears at each end of the shafts are substantially vertically in line. These distances given for the shafts and for the gears, however, are not standard for all implementations. The actual numbers are rather dependent on the amount of force required to generate the necessary torque for each site, which in turn depends on the requirements of the power generator 110 to be driven by the power drop PD 104. The two vertical shafts 116 may be connected to between one to four power Generators 110.

One chain 114 is installed around each set of vertical gears. Therefore any downward force applied to the power drop containers 112 makes the whole system 100 move downward uniformly. These chains 114 and gears are selected so that the teeth of the gears fit into the sockets of the chains 114. In terms of strength and durability these are heavy industrial gear and chains 114, and may resemble the gear-chains combos employed in the industry for moving heavy equipment around.

A set of horizontal power drop containers 112 are connected to these vertically moving chains 114, at particular vertical distances, which again are measured based on the system requirements, for example the height of each power drop container 112 etc.

The operation of the power drop PD 104 begins when the liquid from the container 106 starts filling the power drop container 112 located at the top of the power drop-104. As one of the power drop containers 112 fills up, the weight of the power drop container 112 moves it vertically downward. However, since the power drop container 112 is connected to the chains 114 and the chains 114 are connected to the teeth of the gears, the whole gear-chain system begins to move downward. This movement causes the next power drop container 112 from the back to move to the top, replacing the power drop container 112 that just moved down. As the power drop containers 112 fill up and move downward, eventually the power drop containers 112 that have been filled up will reach the bottom of the chains 114. Rotating around the bottom shaft 116, the power drop container 112 will deposit all of its liquid into the second liquid container number 108, which is located directly beneath the bottom shaft 116.

As the power drop containers 112 fill up on the top one by one, and move downward, they generate torque in both shafts 116 through the gear and chain connections. Therefore, depending on the size of the power drop containers 112 and torque requirements for power generators 110, one to four generators 110 can be driven by the two shafts 116.

On the other hand, as long as the liquid from the first liquid container 106 keeps on filling up the power drop container 112 located near the top of the frame, the Power Drop 104 continues to function without stop. As other figures show, these power drop container 112 can have many different shapes, including small containers that have minimal vertical distance from each other.

Therefore as Power Drop 104 functions, the power drop 104 converts Potential Energy into Torque, and consequently by activating the generators 110, electricity is produced.

Hence, the Power Drop 104 changes the available potential energy of the water in container 106 through the following ways and steps:

Potential Energy→Kinetic Energy→Toque→Electricity

Therefore up to this point, the Mass Activated Pump (MAP) 102 has not been activated because in the process of generating torque, power drop 104 has sacrificed the initial potential energy that was stored in the liquids of the first liquid container 106. The next section of the present invention describes the process through which this lost potential energy is restored and recovered.

Mass Activated Pump (MAP):

The mass activated pump MAP 102 is a complicated and important part of this system. The mass activated pump Map 102 is designed based on employing two scientific laws. These laws, as stated above, are Stevin's Law of Communicating Vessels and Pascal's Law of Transmission of Fluid-pressure.

The mass activated pump MAP 102 can be used in at least two ways.
1. It can be used as an integral part of a whole system for generating electricity, or
2. It can be used independently for moving large amounts of water (millions of gallons/day) to higher elevations.

It should be emphasized that although “Pascal's Law of Transmission of Fluid-pressure” is one of the most widely used scientific laws in the industry, its deployment in this system is different from the way that the industry has been using it. In general, Pascal's law has been employed with the specific purpose of gaining additional force, called Mechanical Advantage. It has been employed to function by sacrificing fluid-movement distance in the smaller cylinder in order to gain force, or Mechanical Advantage (MA), in the larger cylinder. The reason for such implementations is that moving liquid through hydraulic jacks, for example, is easily accomplished. Whereas lifting or moving a heavy weight requires a force that cannot be produced without the MA delivered through implementation of Pascal's Law.

The Mass Activated Pump 102, however, implements this law in reverse, with the intention of sacrificing force for gaining Distance in moving the liquid up vertically in the Transfer Pipe 147. The working theory is that there is enough FREE force to sacrifice (this force will be explained shortly) for gaining the movement in the liquid, or Distance Gain. This distance gained, is in fact the vertical distance (the source of Potential Energy) that the liquid lost as a result of the functioning of the Power Drop 104, as described in previous section. Once this distance gain is accomplished, the water is restored to its previous altitude into the first liquid container 106, thereby restoring the potential energy that Power Drop 104 used in order to generate torque. This will become clear as more description is provided during the examination of the inter-workings of mass activated pump 102.

FIG.-3 depicts the overall functioning and apparatus of the mass activated pump MAP 102. FIG. 6 provides additional details as to how these laws are implemented for moving the liquid to a higher elevation. This of course is accomplished by using the actual MASS of some portion of the liquid in order to move another portion of the same liquid to higher elevation.

The mass activated pump MAP 102 includes a first cylinder 155 and a second cylinder 153 (FIGS. 3 and 6), and the two cylinders may be positioned inside one another. The first cylinder 155 may be defined by the mass power pump wall 123 which may include the first vertical wall 125, the second vertical wall 127 and the horizontal wall 129 and the second cylinder 153 may be defined by the side walls 135. the first cylinder 155 and the second cylinder 153 may be referred to as the Internal and External cylinders respectively. The relative sizes of these cylinders are a portion of the present invention.

These cylinders 153, 155 are related to one another in horizontal size, radius. The cylinders 153, 155 are designed in a way that the outer radius of the first cylinder 155 is about one millimeter smaller than the internal radius of the second cylinder 153. The first cylinder 155, however, is divided into two parts, Bottom and Top.

The radius of the bottom part of the internal cylinder is measured as described above. But the radius of the top part of the first cylinder 155 is chosen based on the torque requirements. This part provides room for any extra force necessary based on the Pascal's formulas.

This arrangement makes it possible for the first cylinder 155 to move up and down inside the second cylinder 153. This also does not leave a lot of room for liquid to move between the two cylinders 153, 155. Further measures are taken to prevent such leaks by implementing wall seals 137, as can be seen in FIG. 3.

Although the remainder of this document refers to these shapes as cylinders for the sake of uniformity of calculations, they can take other forms as well. The mathematical formulas stay the same, but specific part of the formulas related to the calculations of Area and volume will have to change in order to reflect the specific shapes chosen.

These cylinders 153, 155 are both closed at the bottom and open on the top. The height of the first cylinder 155 is about twice the height of the second cylinder 153 (Again, this varies depending on implementation and the vertical distance.). The external cylinder, as depicted in FIG. 3, is connected to a vertical transfer pipe. The purpose of the transfer pipe 147 is to move the liquid from the second cylinder 153 to the first liquid container 106, located above the Power Drop 104, thereby restoring the potential energy lost previously. The transfer pipe 147 is fitted with a Clapper Valve, which limits the movement of the liquid inside the transfer pipe 147 to only one direction, from the second cylinder 153 of the MAP 102 to the first container 106. This also prevents liquid inside the transfer pipe 147 from moving downward into the second cylinders 153 when the first cylinder 155 is empty and is not exerting any force on the second cylinder 153 to counteract the force of the liquid inside the transfer pipe 147. The length of the transfer pipe 147 is from the bottom of the mass activated pump MAP 102 to the top of first liquid container 106.

The first cylinder 155 includes a liquid passage way that when in open state allows liquid to move from the first cylinder 155 to the second cylinder 153. the liquid passage, however, is capped with a bottom valve 143 that will open or close based on system requirements and sensors' activations.

It should be mentioned that since the first cylinder has a larger radius on top than on bottom, a multitude of stabilizing rods 133 have been designed with the system to keep the first cylinder 155 from unnecessary horizontal movements.

The bottom of the first cylinder 155 is padded with some buoyant materials in order to assist the first cylinder 155 in moving up when the the second cylinder 153 is being filling up. However, if it becomes necessary a pair of weight control springs 131 can be added to assist in this process. The strength of the weight control springs 131 which will be calculated to counteract the weight of the first cylinders 155, will be considered as part of the Pascal's calculations.

Functioning Process:

Following describes the process through which the mass activated pump MAP 102 moves liquid from the second liquid container 108 to a higher elevation and into the first liquid container number 106.

Phase 1: Functioning starts with the second cylinder 153 filled with liquid to the upper part of the distance marked as L-2, in FIG.-6. Therefore the bottom of the first cylinder 155 has reached the point inside the second cylinder 153 marked as “Upper Limit Stop”. Once the first cylinder 155 reaches this point, it is picked up by the sensor(s) located at the upper limit stop points.

The sensors will force the one way valve 143 to be closed. Once the one way valve is closed, then the first cylinder 155 and the second cylinders 153 are completely disconnected. The one millimeter gap should be neglected for now, as it will be explained.

At this point then a system of “Confined Fluid” is created between the the second cylinder 153 and the transfer pipe 147 through the connection at the bottom right side of the external cylinder to the transfer pipe 147. The clapper valve has no impact because of two factor.
1. The fluid movement direction is only away from the second cylinder 153, into the transfer pipe 147.
2. The fact that the liquid inside the first cylinder is calculated to generate a force greater than the force generated by the liquid inside the transfer pipe 147 (and converted through Pascal's Laws, based on the difference between the radiuses of second cylinder 153 and the transfer pipe 147.).

Therefore, this system of the confined fluid, created between the second cylinder 153 and the transfer pipe 147, is subject to Pascal's Laws. It is important to notice that the first cylinder 155 will be providing the FREE FORCE for this system of confined fluid when the sensors open its valve. This FREE FORCE is the weight of the water that will fill up the first cylinder 155. Considering, however, that at this time the first cylinder 155 is empty, liquid seemingly should flow back from the transfer pipe 147 into the external cylinder. However, the Clapper Valve has been put in place to prevent such flow.

There are three forces in play here.
1. F1 is generated by the weight of the liquid in the transfer pipe 147.
2. F2 is the force that F1 exerts on the larger cylinder of the confined liquid, or the second cylinder 153. This force is calculated by Pascal's laws, and is the conversion of F1. How much F2 is larger than F1 depends on the difference between the radius of the cylinder 153 and radius of the transfer pipe 147. In this case, for the radius of the transfer pipe 147 and the radius of the second cylinder 153 an example is provided at the end.
3. F(C), the FREE FORCE, is the force generated by the first cylinder 155 on the second cylinder 153. If this system is to work properly, then F(C) MUST be larger than F2.

Now the sensors open the pipe from the second liquid container 108, which fills up the first cylinder 155. The weight of the liquid contained in both sections of the internal cylinder, F(C), becomes much larger than F2, which is calculated by converting F1 based on the radiuses of second cylinder 153 and the transfer pipe 147. This will automatically open the clapper valve 149 of the transfer pipe 147, and all of the water contained in the second cylinder 153 will be forced to flow upward and into the first liquid container 106, through the transfer pipe 147. As the liquid flows out of the second cylinder 153, the first cylinder 155 will steadily move down.

Phase 2: As the first cylinder 155 moves down and forces the liquid to flow into first liquid container 106, it will reach the lower sensor. The sensor will cause the one way valve 143 to open. The clapper valve also automatically closes the transfer pipe 147. Now, with the one way valve 143 open, the first cylinder 155 and the second cylinder 153 become two “Communicating Vessels”. Our system now is governed by the Stevin's Law of Communicating Vessels. This law governs that the liquid inside such containers will have to come to the same level. This means that the water from the first cylinder 155 will flow forcefully into the second cylinder 153 through the one way valve 143 (and four small pipes), that is now in the open state, in order for the water in both the first cylinder 155 and the second cylinder 153 to come to the same level. As the water flows downward into the second cylinder 153, it pushes the first cylinder 155 upward, until the first Cylinder 155 reaches the level L2. As stated before, if additional force is necessary to move up the internal cylinder, then the “weight control springs” 131 will be employed.

Phase 3: Again, once the L2 limit is reached, the one way valve 143 is shut and the pipe from the second container 108 opens. But as soon as the one way valve 143 is closed, our system is no longer governed by the Stevin's law. Instead, again, the first and second cylinders 155, 153 will disconnect. As a result, once more, the cylinder 153 and the transfer pipe 147 will form a system of “Confined Fluid”, and are governed by Pascal's law.

Phase 3, therefore, is the same as phase 1. That means we have a system that perpetually moves between phase 1 and phase 2, which will move water from the second liquid container 108 into the first liquid container 106.

However, since the Power Drop 104 moves the liquid from the first liquid container 106 into the second liquid container 108, this system works properly. That is because Power Drop 104 takes liquid from the first liquid container 106, moves the power drop containers 112 and generates torque, then transfers the same liquid into the second container 108.

### Example

In this example, as stated before, the the second cylinder 153 and the transfer pipe 147 form both sides of the confined liquid containers, whose force relationship is governed by Pascal's law and calculated based on their radiuses.
1. Transfer Pipe 147 produces force F1, denoted as F(t)
2. The second liquid cylinder 153 has force F2 exerted on it at the entrance of the transfer pipe 147. F2 is the counterpart to F1, and is calculated based on converting F1 through Pascal's laws.
3. The second cylinder 153 also has the force F(C), generated in it by the the first cylinder 155.

Radius of Transfer Pipe 147 is taken as =1 inch; r(t)=1″

Area; A(t)=r*r*3.14→1*1*3.14→A(t)=3.14

Length of transfer pipe 147 is taken to be 20 feet, Hence,

Transfer pipe 147 height: D(t) in inches=20*12; D(t)=240″

Weight of Water per cubic inch=0.036 lbs/cubic inch

Therefore,

Force generated by the liquid in the Transfer Pipe 147 is:

F(t)=A(t)*D(t)*(weight of water per cubic inch)

F(t)=3.14*240*0.036=27.12 lbs

Also;

P1 (Pressure inside Transfer Pipe 147)

P2 (Pressure inside the second Cylinder 153)

Using Pascal's Law, the force exerted on the second Cylinder 153 by the weight of the liquid in the Transfer Pipe 147 is calculated:

By Pascal's Law: P1=P2; and (P=F/A)→F1/A1=F2/A2

Therefore: →F2=(F1*A2)/A1

Radius of the second Cylinder is taken as =6 inches. Hence:

Area of the second cylinder=6*6*3.14=113 square Inches

F2=(F1*A2)/A1→F2=(27.12*113)/3.14→F2=976 lbs

F2=976 lbs

This is the force exerted on the second cylinder 153 side by force of the liquid inside the Transfer Pipe 147, exerted at the point where transfer pipe 147 is connected to this cylinder, second cylinder 153.

This force should be overcome in order to move up the liquid inside the Transfer Pipe 147.

Therefore, the force generated by the weight of liquid in the first cylinder 155 should be greater than this force.

Force GENERATED by the first cylinder 155 and EXERTED on the second cylinder 153, at the horizontal wall 141, is F(C), which is the combination of forces generated by the Bottom part F(B) and the Top part F(T) of the first cylinder 155.

F(C)=F(B)+F(T)

Radius of the Bottom of the first cylinder 155 is slightly less than 6 inches. Hence

r(B)=5.9″ with the height of bottom part as, D=36″ And;

r(T)=15 “with the height of top part as, D=36”

As, based on above calculations;

F=A*D*(weight of water per cubic inches)→F=r*r*3.14*D*0.036

F(B)=5.9*5.9*3.14*36*0.036→F(B)142 lbs

F(T)=15*15*3.14*36*0.036→F(T)=916 lbs

F(C)=F(B)+F(T)→F(C)=916+142→F(C)=1058 lbs

F(springs)˜30 lbs;→

Actual F(C)=F(C)−F(springs); Just in case springs are used.

F(C)=1058 lbs−30 lbs→F(C)=1028 lbs

F(C)=1028 lbs>F2=976 lbs

This calculation is valid only for this implementation and the relevant sizes. However, the same calculation process can be used for any implementation. For any implementation it would be reasonable to start with the amount of torque necessary to drive the Electric Generator(s) 110. This in turn should be calculated based on the amount of Electricity required. If the mass activated pump 102 is implemented independently, and solely moving water to higher elevations, then the only consideration should be the amount of liquid to be moved and the number of mass activated pumps 102 cascaded to accomplish that.

1) A mass activated generator to generate torque, comprising:
a power drop device to receive liquid to drive a continuous loop device to generate the torque;
a mass activated pump to receive the liquid from the bottom of the continuous loop device and to pump the liquid to the container at the top of the continuous loop device
wherein the continuous loop device includes a pair of torque shafts to drive an electric generator and a plurality of power drop containers connected to the torque shafts to receive the liquid and to transfer the liquid to the mass activated pump.

2) A mass activated generator to generate torque as in claim 1, wherein the continuous loop device includes a pair of chains to connect the power drop containers to the torque shafts.

3) A mass activated generator to generate torque as in claim 1, wherein the mass activated pump includes a first liquid container to move with respect to a second liquid container.

4) A mass activated generator to generate torque as in claim 3, wherein the first liquid container receives the liquid from the power drop containers.

5) A mass activated generator to generate torque as in claim 3, wherein the first liquid container includes a one-way valve to transferred the liquid to the second liquid container.

6) A mass activated generator to generate torque as in claim 3, wherein the second liquid container is connected to the power drop device by a transfer pipe.

7) A mass activated generator to generate torque as in claim 6, wherein the second liquid container includes a transfer valve to connect to the transfer pipe.

8) A mass activated generator to generate torque as in claim 5, wherein the one-way valve is positioned within a bottom wall of the first liquid container.
